(19) United States
(12) Patent Application Publication
(10) Pub. No.: US 2010/0331480 A1
(43) Pub. Date: Dec. 30, 2010

(54) HARDENABLE COMPOSITIONS CONTAINING SOFT-ELASTIC SILYLATED POLYURETHANES

(75) Inventors: Noelle Wrubbel, Duesseldorf (DE); Helene Boudet, Duesseldorf (DE); Andrea Krlejova, Duesseldorf (DE); Andreas Bolte, Duesseldorf (DE); Lars Zander, Rommerskirchen (DE); Johann Klein, Duesseldorf (DE); Christiane Kunze, Koeln (DE)

Correspondence Address: HENKEL CORPORATION, One Henkel Way, ROCKY HILL, CT, 06067, US

(73) Assignee: Henkel AG & Co. KGaA, Duesseldorf (DE)

(21) Appl. No.: 12/832,356

(22) Filed: Jul. 8, 2010

Related U.S. Application Data
(63) Continuation of application No. PCT/EP2009/050234, filed on Jan. 9, 2009.

(30) Foreign Application Priority Data
Jan. 10, 2008 (DE) 102008003743.5

(51) Int. Cl. C08L 75/04; C08G 71/04

(52) U.S. Cl. 524/588; 528/29

(57) ABSTRACT

Silyated polyurethanes can be manufactured by (A) converting (i) at least one polyol compound A with a molecular weight of 500-20,000 Dalton, in particular 4000-10,000 Dalton, (ii) with a dihalogenide to a polyol compound B with a molecular weight of 4000-40,000 Dalton, in particular 8000-20,000 Dalton, and subsequent (B) conversion of this polyol B with one or more isocyanatosilanes of formula (1): OCN—R—Si—(R1)m(-OR2)3-m where m is 0.1 or 2, each R2 is an alkyl radical with 1 to 4 carbon atoms, each R1 is an alkyl radical with 1 to 4 carbon atoms and R is a difunctional organic pump. These silylated polyurethanes are suited to use as adhesives, sealant or coating agent in preparations containing one or more such silylated polyurethane.

### CROSS-REFERENCE TO RELATED CASES

This application is a continuation of International Application No. PCT/EP2009/050234, filed Jan. 9, 2009 and published on Jul. 16, 2009 as WO 2009/087228, which claims priority from German Patent Application No. 102008003743.5 filed Jan. 10, 2008, the contents of each of which are incorporated herein by reference in their entirety.

### FIELD OF THE INVENTION

The present invention relates to silane-crosslinking, curable compositions, their preparation and their use in adhesives, sealants and coating agents.

Polymer systems having reactive alkoxysilyl groups are known. In the presence of atmospheric moisture these alkoxysilane-terminated polymers are capable even at room temperature of fusing with one another and eliminating the alkoxy groups. Depending on the content of alkoxysilyl groups and their structure, this causes mainly long-chain polymers (thermoplastics), relatively coarse-meshed three-dimensional networks (elastomers) or highly crosslinked systems (thermosets) to form.

The polymers usually have an organic basic framework bearing alkoxysilyl groups at the ends. The organic basic framework can be polyurethane, polyester, polyether, etc., for example.

One-component, moisture-curing adhesives and sealants have played a significant role in many technical applications for years. In addition to the polyurethane adhesives and sealants having free isocyanate groups and the traditional silicone adhesives and sealants based on dimethyl polysiloxanes, the use of so-called modified silane adhesives and sealants has also gained ground in recent times. In this last group the main component of the polymer backbone is a polyether and the reactive, crosslinkable end groups are alkoxysilyl groups. As compared with polyurethane adhesives and sealants, modified silane adhesives and sealants have the advantage of being free from isocyanate groups, in particular monomeric diisocyanates, and they also have the characteristic feature of a broad adhesive spectrum on a wide range of substrates without surface pretreatment with primers.

U.S. Pat. No. 4,222,925 A and U.S. Pat. No. 3,979,344 A describe siloxane-terminated organic sealant compositions which are curable even at room temperature, based on reaction products of isocyanate-terminated polyurethane prepolymers with 3-aminopropyl trimethoxysilane or 2-aminoethyl-, 3-aminopropyl methoxysilane to isocyanate-free siloxane-terminated prepolymers. However, adhesives and sealants based on these prepolymers have unsatisfactory mechanical properties, particularly in terms of their elongation and tear strength.

The methods listed below for preparing silane-terminated prepolymers based on polyethers have already been described:
Copolymerization of unsaturated monomers with examples having alkoxysilyl groups, such as e.g. vinyl trimethoxysilane.
Grafting of unsaturated monomers such as vinyl trimethoxysilane onto thermoplastics such as polyethylene.
Hydroxy-functional polyethers are reacted with unsaturated chlorine compounds, e.g. allyl chloride, in an ether synthesis in polyethers having terminal olefinic double bonds, which in turn are reacted with hydrosilane compounds having hydrolyzable groups, such as e.g. HSi(OCH₃)₃, in a hydrosilylation reaction under the catalytic influence of for example transition metal compounds of the 8^{th} group to form silane-terminated polyethers.
In another method the polyethers containing olefinically unsaturated groups are reacted with a mercaptosilane such as for example 3-mercaptopropyl trialkoxysilane.
In a further method hydroxyl-group-containing polyethers are first reacted with diisocyanates or polyisocyanates, which are then in turn reacted with amino-functional silanes or mercapto-functional silanes to form silane-terminated prepolymers.
A further possibility provides for reacting hydroxy-functional polyethers with isocyanato-functional silanes such as for example 3-isocyanatopropyl trimethoxysilane.

These preparation methods and the use of the aforementioned silane-terminated prepolymers in adhesive/sealant applications are mentioned for example in the following patents: U.S. Pat. No. 3,971,751, EP-A-70475, DE-A-19849817, U.S. Pat. No. 6,124,387, U.S. Pat. No. 5,990,257, U.S. Pat. No. 4,960,844, U.S. Pat. No. 3,979,344, U.S. Pat. No. 3,971,751, U.S. Pat. No. 3,632,557, DE-A-4029504, EP-A-601021 or EP-A-370464.

EP-A-0931800 describes the preparation of silylated polyurethanes by reacting a polyol component having a terminal unsaturation of less than 0.02 meq/g with a diisocyanate to form a hydroxyl-terminated prepolymer, which is then reacted with an isocyanatosilane of the formula OCN—R—Si—(X)ₘ(—OR¹)₃₋ₘ, in which m is 0, 1 or 2 and each R¹ residue is an alkyl group having 1 to 4 C atoms and R is a difunctional organic group. According to the teaching of this publication such silylated polyurethanes have a superior combination of mechanical properties and cure within reasonable times to form a low-tack sealant, without exhibiting excessive viscosity.

WO-A-2003 066701 discloses polyurethane prepolymers having alkoxysilane and OH end groups and based on high-molecular-weight polyurethane prepolymers, having reduced functionality for use as binders for low-modulus sealants and adhesives. To this end a polyurethane prepolymer consisting of a diisocyanate component having an NCO content of 20 to 60% and a polyol component, comprising a polyoxyalkylene dial with a molecular weight of between 3000 and 20,000 as the main component, should first be reacted, the reaction being stopped when 50 to 90% of the OH groups have been converted. The reaction product should then be reacted further with a compound having alkoxysilane and amino groups. Through these measures prepolymers having a relatively low average molecular weight and low viscosity should be obtained, which should guarantee the achievement of excellent properties.

Moisture-curing alkoxysilane-functional polyether urethane compositions are known from WO-A-2005 042605 which contain 20 to 90 wt. % of a polyether urethane A having two or more reactive silane groups and 10 to 80 wt. % of a polyether urethane B having one reactive silane group. The polyether urethane A should have polyether segments having a number-average molecular weight (Mₙ) of at least 3000 and an unsaturation of less than 0.04 meq/g, and the reactive silane groups should be inserted by reacting an isocyanate-reactive group with a compound of the formula OCN—Y—Si—(X)₃. The polyether urethane B should have one or more polyether segments having a number-average molecular weight (Mₙ) of 1000 to 15,000 and the reactive silane groups should be inserted by reacting an isocyanate group with a compound of the formula HN(R₁)—Y—Si—(X)₃. R₁ is an alkyl, cycloalkyl or aromatic group having 1 to 12 C atoms, X is an alkoxy group and Y is a linear radical having 2 to 4 C atoms or a branched radical having 5 to 6 C atoms.

To reduce the functionality and hence the crosslink density of moisture-curing alkoxysilane-terminated polyurethanes, WO-A-92/05212 proposes incorporating monofunctional isocyanates mixed with diisocyanates in the synthesis. Monoisocyanates are known to have a very high vapor pressure and owing to their toxicity they are potentially harmful materials from a health and safety perspective.

EP-A-1396513 describes a room-temperature-curing composition which contains a polyoxyalkylene polymer (A) having a molecular weight of 8000 to 50,000 (calculated from the hydroxyl value) and containing hydrolyzable silicon groups of the formula —SiXₐR¹₃₋ₐ. X here is a hydroxyl group or a hydrolyzable group, a is 1, 2 or 3 and R¹ is a C₁₋₂₀ substituted or unsubstituted monovalent organic group. The composition should contain both polyoxyalkylene polymers (A) in which a is 1 or 2 and those in which a is 3. If there is more than one R¹ present, the majority of R¹ can be the same or different, and if there is more than one X present, the majority of X can be the same or different. The room-temperature-curing composition is intended for use as a sealant, impregnating agent, adhesive or coating agent.

There is also a need for isocyanate-free compositions for preparing one-component or two-component adhesives and sealants which have an acceptable cure time and exhibit particularly good elasticity and extensibility after curing. There is further a desire for an efficient synthesis route and for compositions which exhibit no residual tackiness.

The object of the present invention is therefore to provide isocyanate-free, crosslinkable compositions having high elasticity and good strength with a very low E-modulus. A user-friendly cure time is also desired.

The manner in which the object is achieved according to the invention can be ascertained from the claims.

It consists substantially in the provision of a method for preparing a silylated polyurethane, comprising:
(A) reacting
   (i) at least one polyol compound A having a molecular weight of 500 to 20,000 daltons, in particular 4000 to 10,000 daltons, and a terminal unsaturation of less than 0.02 meq/g
   (ii) with a dihalide to form a polyol compound B having a molecular weight of 4000 to 40,000 daltons, in particular 8000 to 20,000 daltons, and subsequently
(B) reacting this polyol B with one or more isocyanatosilanes of the formula (I):

OCN—R—Si—(R¹)ₘ(—OR²)₃₋ₘ (I)

in which m is 0, 1 or 2, each R² is an alkyl residue having 1 to 4 carbon atoms, each R¹ is an alkyl residue having 1 to 4 carbon atoms and R is a difunctional organic group, in order to cap the hydroxyl groups of the polyol with the isocyanatosilane.

In a preferred embodiment of the method according to the invention R is a difunctional straight-chain or branched, saturated or unsaturated alkylene group having a main chain of 1 to 6 carbon atoms, particularly preferably having 2 to 6 carbon atoms, in particular a methylene and most particularly preferably an ethylene or propylene group.

The invention also relates to a silylated polyurethane prepared by a method which involves reacting at least one polyol compound A having a molecular weight of 500 to 20,000 daltons, in particular 4000 to 10,000 daltons, and a terminal unsaturation of less than 0.02 meq/g with a dihalide to form a polyol compound B having an average molecular weight of 4000 to 40,000 daltons, in particular 8000 to 20,000 daltons, and subsequently reacting this high-molecular-weight polyol B with one or more isocyanatosilanes of formula (I) to form a silylated polyurethane having alkoxysilyl groups as reactive end groups.

“Silylated polyurethanes” within the meaning of this invention are also compounds having more than one but less than three urethane groups per molecule.

The polyol compound B formed in this way having a molecular weight of 4000 to 40,000 daltons, in particular 8000 to 20,000 daltons, can optionally be reacted in a subsequent reaction with a diisocyanate in a stoichiometric excess of the polyol compound relative to the diisocyanate compound to form a polyurethane prepolymer which is hydroxyl-terminated. This is then subsequently reacted further with one or more isocyanatosilanes of formula (I) to form a silylated polyurethane having a very high molecular weight. This means that the present invention also provides a method for preparing a silylated polyurethane which comprises
(A) reacting
   (i) at least one polyol compound A having a molecular weight of 500 to 20,000 daltons, in particular 4000 to 10,000 daltons, and a terminal unsaturation of less than 0.02 meq/g
   (ii) with a dihalide to form a polyol compound B having a molecular weight of 4000 to 40,000 daltons, in particular 8000 to 20,000 daltons, and subsequently
(B) reacting this polyol B with a diisocyanate in stoichiometric excess of the polyol to form a polyurethane prepolymer C and subsequently
(C) reacting this prepolymer C with one or more isocyanatosilanes of the formula (I):

OCN—R—Si—(R¹)ₘ(—OR²)₃₋ₘ (I)
in which m is 0, 1 or 2, each R² is an alkyl residue having 1 to 4 carbon atoms, each R¹ is an alkyl residue having 1 to 4 carbon atoms and R is a difunctional organic group.

The invention thus also relates to a silylated polyurethane prepared by a method which comprises
(A) reacting
   (i) at least one polyol compound A having a molecular weight of 500 to 20,000 daltons, in particular 4000 to 10,000 daltons, and a terminal unsaturation of less than 0.02 meq/g
   (ii) with a dihalide to form a polyol compound B having a molecular weight of 4000 to 40,000 daltons, in particular 8000 to 20,000 daltons, and subsequently
(B) reacting this polyol B with a diisocyanate in stoichiometric excess of the polyol to form a polyurethane prepolymer C and subsequently
(C) reacting this prepolymer C with one or more isocyanatosilanes of the formula (I):

OCN—R—Si—(R¹)ₘ(—OR²)₃₋ₘ (I)
in which m is 0, 1 or 2, each R² is an alkyl residue having 1 to 4 carbon atoms, each R¹ is an alkyl residue having 1 to 4 carbon atoms and R is a difunctional organic group.

In a further preferred embodiment of the method according to the invention and the silylated polyurethane according to the invention m is zero or one.

The present invention also provides a moisture-curing preparation containing one or more silylated polyurethanes according to the invention or one or more silylated polyurethanes prepared by a method according to the invention, and their use as an adhesive, sealant or coating agent. In addition to the silylated polyurethanes according to the invention this preparation can also contain plasticizers, fillers, catalysts and further auxiliary substances and additives.

A large number of polymers bearing at least two hydroxyl groups can be used in principle as polyol compounds, with polyesters, polyols, hydroxyl-group-containing polycaprolactones, hydroxyl-group-containing polybutadienes, polyisoprenes, dimer diols or OH-terminated polydimethyl siloxanes and the hydrogenation products thereof and also hydroxyl-group-containing polyacrylates or polymethacrylates being cited by way of example.

However, polyalkylene glycols, in particular polyethylene oxides and/or polypropylene oxides, are most particularly preferred as polyols.

Polyols containing polyether as the polymer framework have a flexible and elastic structure, not only at the end groups but also in the polymer backbone. They can be used for preparing compositions having further improved elastic properties. Polyethers are not only flexible in their basic framework but also resistant at the same time. Thus unlike polyesters, for example, polyethers are not attacked or decomposed by water and bacteria.

Polyethylene oxides and/or polypropylene oxides are therefore particularly preferably used.

According to a further preferred embodiment of the composition according to the invention the molecular weight Mₙ of the polymer framework of the polyol compounds A is between 500 and 20,000 g/mol (daltons), the terminal unsaturation being less than 0.02 meq/g.

These molecular weights are particularly advantageous as these polyols are readily available commercially. Molecular weights of 4000 to 10,000 g/mol (daltons) are particularly preferred.

Polyoxyalkylenes, in particular polyethylene oxides or polypropylene oxides, having a polydispersity PD of less than 2, preferably less than 1.5, are most particularly preferably used.

The molecular weight Mₙ is understood to be the number-average molecular weight of the polymer. Like the weight-average molecular weight M_{w}, this can be determined by gel permeation chromatography (GPC, also known as SEC). This method is known to the person skilled in the art. The polydispersity derives from the average molecular weights M_{w} and Mₙ. It is calculated as PD=M_{w}/Mₙ.

Particularly advantageous viscoelastic properties can be achieved if polyoxyalkylene polymers A having a narrow molar mass distribution and hence a low polydispersity are used as the polymeric basic frameworks. These can be prepared by means of double metal cyanide catalysis (DMC catalysis), for example. These polyoxyalkylene polymers have the characteristic feature of a particularly narrow molar mass distribution, a high average molar mass and a very low number of double bonds at the ends of the polymer chains.

Such polyoxyalkylene polymers have a polydispersity PD (M_{w}/Mₙ) of at most 1.7. Particularly preferred organic basic frameworks are for example polyethers having a polydispersity of around 1.01 to around 1.3, in particular around 1.05 to around 1.18, for example around 1.08 to around 1.11 or around 1.12 to around 1.14.

In a first step in the preparation of the silylated polyurethanes according to the invention the aforementioned polyol compound A having a molecular weight Mₙ of between 500 and 20,000 g/mol, in particular between 4000 and 10,000 g/mol, is first converted with alkali or alkaline-earth compounds in a Williamson ether synthesis into the corresponding alcoholate, which is then reacted with a dihalide to form a polyol compound B having an average molecular weight Mₙ of 4000 to 40,000 g/mol (daltons), in particular 8000 to 20,000 g/mol (daltons). In the subsequent step this polyol compound B is reacted with one or more isocyanatosilanes of formula (I) such that the hydroxyl groups are completely capped by the isocyanatosilane.

The alkali or alkaline-earth compounds necessary for alcoholate formation can be selected from the metals K, Na or hydrides thereof, such as NaH, hydroxides, or low alcoholates such as NaOCH₃, KOCH₃ or K tert-butoxide or the corresponding alkaline-earth metals or compounds.

A series of haloorganic compounds having two halogen atoms per molecule can be used as the dihalide in a method according to the invention or to prepare a polyurethane according to the invention. Specific examples of these are bis(chloromethyl)benzene, bis(chloromethyl)ether, bis(bromomethyl)benzene, with 1,3-bis(bromomethyl)benzene being particularly preferably used. Thus the polyol compound B formed in this way is a polyoxyalkylene arylene compound.

The isocyanatosilanes listed below for example are suitable for the subsequent reaction of the polyol B with one or more isocyanatosilanes:
Methyldimethoxysilyl methyl isocyanate, ethyldimethoxysilyl methyl isocyanate, methyldiethoxysilyl methyl isocyanate, ethyldiethoxysilyl methyl isocyanate, methyldimethoxysilyl ethyl isocyanate, ethyldimethoxysilyl ethyl isocyanate, methyldiethoxysilyl ethyl isocyanate, ethyldiethoxysilyl ethyl isocyanate, methyldimethoxysilyl propyl isocyanate, ethyldimethoxysilyl propyl isocyanate, methyldiethoxysilyl propyl isocyanate, ethyldiethoxysilyl propyl isocyanate, methyldimethoxysilyl butyl isocyanate, ethyldimethoxysilyl butyl isocyanate, methyldiethoxysilyl butyl isocyanate, diethylethoxysilyl butyl isocyanate, ethyldiethoxysilyl butyl isocyanate, methyldimethoxysilyl pentyl isocyanate, ethyldimethoxysilyl pentyl isocyanate, methyldiethoxysilyl pentyl isocyanate, ethyldiethoxysilyl pentyl isocyanate, methyldimethoxysilyl hexyl isocyanate, ethyldimethoxysilyl hexyl isocyanate, methyldiethoxysilyl hexyl isocyanate, ethyldiethoxysilyl hexyl isocyanate, trimethoxysilyl methyl isocyanate, triethoxysilyl methyl isocyanate, trimethoxysilyl ethyl isocyanate, triethoxysilyl ethyl isocyanate, trimethoxysilyl propyl isocyanate (e.g. GF 40, Wacker), triethoxysilyl propyl isocyanate, trimethoxysilyl butyl isocyanate, triethoxysilyl butyl isocyanate, trimethoxysilyl pentyl isocyanate, triethoxysilyl pentyl isocyanate, trimethoxysilyl hexyl isocyanate, triethoxysilyl hexyl isocyanate. Methyldimethoxysilyl methyl isocyanate, methyldiethoxysilyl methyl isocyanate, methyldimethoxysilyl propyl isocyanate and ethyldimethoxysilyl propyl isocyanate or the trialkoxy analogs thereof are preferred; the isocyanatosilane of formula (I) is particularly preferably 3-isocyanatopropyl trimethoxysilane or 3-isocyanatopropyl triethoxysilane.

The isocyanatosilane(s) is (are) used here in an at least stoichiometric amount relative to the hydroxyl groups of the polyol; however, a slight stoichiometric excess of the isocyanatosilanes relative to the hydroxyl groups of the polyol is preferred. This stoichiometric excess is between 0.5 and 10, preferably between 1.2 and 2, equivalents of isocyanate groups relative to the hydroxyl groups.

The following diisocyanates can be used for the conversion of the polyol compound B into a hydroxyl-terminated polyurethane prepolymer to be used as an alternative:
Ethylene diisocyanate, 1,4-tetramethylene diisocyanate, 1,4-tetramethoxybutane diisocyanate, 1,6-hexamethylene diisocyanate (HDI), cyclobutane-1,3-diisocyanate, cyclohexane-1,3 and -1,4 diisocyanate, bis-(2-isocyanatoethyl)fumarate, 1-isocyanato-3, 3, 5-trimethyl-5-isocyanatomethyl cyclohexane (isophorone diisocyanate, IPDI), 2,4- and 2,6-hexahydrotoluylene diisocyanate, hexahydro-1,3- or -1,4-phenylene diisocyanate, benzidine diisocyanate, naphthalene-1,5-diisocyanate, 1,6-diisocyanato-2,2,4-trimethylhexane, 1,6-diisocyanato-2,4,4-trimethylhexane, xylylene diisocyanate (XDI), tetramethylxylylene diisocyanate (TMXDI), 1,3- and 1,4-phenylene diisocyanate, 2,4- or 2,6-toluylene diisocyanate (TDI), 2,4′-diphenylmethane diisocyanate, 2,2′-diphenylmethane diisocyanate or 4,4′-diphenylmethane diisocyanate (MDI) and isomer mixtures thereof. Also suitable are partially or completely hydrogenated cycloalkyl derivatives of MDI, for example completely hydrogenated MDI (H12-MDI), alkyl-substituted diphenylmethane diisocyanates, for example mono-, di-, tri- or tetraalkyl diphenylmethane diisocyanate and the partially or completely hydrogenated cycloalkyl derivatives thereof, 4,4′-diisocyanatophenyl perfluoroethane, phthalic acid bis-isocyanatoethyl ester, 1-chloromethylphenyl-2,4- or -2,6-diisocyanate, 1-bromomethylphenyl-2,4- or -2,6-diisocyanate, 3,3-bis-chloromethyl ether-4,4′-diphenyl diisocyanate, sulfur-containing diisocyanates, such as can be obtained by reacting 2 mol of diisocyanate with 1 mol of thiodiglycol or dihydroxydihexyl sulfide, the diisocyanates of dimer fatty acids, or mixtures of two or more of the cited diisocyanates.

In a preferred embodiment of the method according to the invention or of the polyurethane according to the invention the diisocyanate compound is selected from the group consisting of 2,4-toluene diisocyanate, 2,6-toluene diisocyanate, 4,4′-diphenylmethane diisocyanate, 2,4′-diphenylmethane diisocyanate, 1-isocyanato-3,3,5-trimethyl-5-isocyanatomethyl cyclohexane (isophorone diisocyanate, IPDI), 4,4′-dicyclohexylmethane diisocyanate isomers, tetramethylxylylene diisocyanate (TMXDI), and mixtures thereof.

Monofunctional compounds can optionally also be incorporated in the preparation of the hydroxyl-terminated polyurethane prepolymer.

According to the invention such compounds having isocyanate-reactive groups with a functionality of 1 are suitable as monofunctional compounds. In principle all monofunctional alcohols, amines or mercaptans can be used for this purpose, these are in particular monofunctional alcohols having up to 36 carbon atoms, monofunctional primary and/or secondary amines having up to 36 carbon atoms or monofunctional mercaptans having up to 36 carbon atoms. However, mixtures of polyalcohols, polyamines and/or polymercaptans can also be used as monofunctional compounds, provided that their average functionality is well below 2.

In the context of a further preferred embodiment of the method according to the invention or of the polyurethane according to the invention the polyol mixture additionally contains at least one compound which is monofunctional with regard to isocyanates, selected from monoalcohols, monomercaptans, monoamines or mixtures thereof, and the proportion of monofunctional compound in the mixture of polyol and the monofunctional compound is 1 to 40 mol %, preferably 1 to 20 mol %.

Monoalcohols such as benzyl alcohol, methanol, ethanol, the isomers of propanol, butanol and hexanol, monoethers of ethylene glycol and/or diethylene glycol, and the primary alcohols having 8 to 18 C atoms which are obtainable by reducing fatty acids, such as octanol, decanol, dodecanol, tetradecanol, hexadecanol and octadecanol, are particularly preferred for example, particularly in the form of technical mixtures thereof. Monoalcohols having 4 to 18 C atoms are preferred, as low alcohols can be prepared anhydrously only with difficulty.

Monoalkyl polyether alcohols of differing molecular weight can also be used, a number-average molecular weight of between 1000 and 2000 being preferred. A preferred representative is monobutyl propylene glycol, for example.

Saturated fatty alcohols having up to 26 carbon atoms can also be used, preferably those having up to 22 carbon atoms, which are synthesized on an industrial scale by reduction (hydrogenation) of fatty acid methyl esters. Hexanol, octanol, nonanol, decanol, lauryl alcohol, myristyl alcohol, cetyl alcohol, stearyl alcohol, gadoleyl alcohol and behenyl alcohol or the Guerbet alcohols 2-hexyl decanol, 2-octyl dodecanol, 2-decyl tetradecanol, 2-dodecyl hexadecanol, 2-tetradecyl octadecanol, 2-hexadecyl eicosanol, Guerbet alcohol consisting of erucyl alcohol, behenyl alcohol and ocenols can be cited by way of example.

Mixtures resulting from the guerbetization of technical fatty alcohols together with the other aforementioned alcohols can optionally be used.

The proportion of monofunctional compound(s) is 0 to 40 mol %, relative to the polyol mixture, a proportion of monofunctional compound(s) of 15 to 30 mol % being particularly preferred.

The stoichiometric excess of the sum of polyol compounds and monofunctional compound relative to the diisocyanate compound or mixture of diisocyanates used is 1.1 to 2.0, preferably between 1.2 and 1.5. This ensures that a polyurethane prepolymer having terminal hydroxyl groups is formed as the reaction product of the polyol B.

The subsequent reaction of the hydroxyl-terminated polyurethane prepoiymer mixture with the isocyanatosilane to form the silylated polyurethane takes place in the manner described above for the direct reaction of the polyol B.

An adhesive and sealant preparation according to the invention can also contain, in addition to the aforementioned silylated polyurethane compounds, further auxiliary substances and additives, which impart improved elastic properties, improved resilience, a sufficiently long processing time, a fast setting speed and low residual tackiness to this preparation. These auxiliary substances and additives include for example plasticizers, stabilizers, antioxidants, fillers, reactive thinners, desiccants, adhesion promoters and UV stabilizers, rheological auxiliary agents, colored pigments or pigment pastes and/or optionally also a small amount of solvent.

Suitable as plasticizers are for example adipic acid esters, azelaic acid esters, benzoic acid esters, butyric acid esters, acetic acid esters, esters of higher fatty acids having around 8 to around 44 C atoms, esters of OH-group-bearing or epoxidized fatty acids, fatty acid esters and fats, glycolic acid esters, phosphoric acid esters, phthalic acid esters, linear or branched alcohols containing 1 to 12 C atoms, propionic acid esters, sebacic acid esters, sulfonic acid esters, thiobutyric acid esters, trimellitic acid esters, citric acid esters and esters based on nitrocellulose and polyvinyl acetate, as well as mixtures of two or more thereof. The asymmetrical esters of adipic acid monooctyl esters with 2-ethyl hexanol (Edenol DOA, Cognis Deutschland GmbH, Düsseldorf) or esters of abietic acid are particularly suitable.

Of the phthalic acid esters, dioctyl phthalate (DOP), dibutyl phthalate, diisoundecyl phthalate (DIUP) or butylbenzyl phthalate (BBP), or the derived hydrogenated derivatives thereof, are suitable for example, of the adipates, dioctyl adipate (DOA), diisodecyl adipate, diisodecyl succinate, dibutyl sebacate or butyl oleate are suitable.

Likewise suitable as plasticizers are the pure or mixed ethers of monofunctional, linear or branched C₄₋₁₆ alcohols or mixtures of two or more different ethers of such alcohols, for example dioctyl ether (available as Cetiol OE, Cognis Deutschland GmbH, Düsseldorf).

Also suitable as plasticizers are end-capped polyethylene glycols, for example polyethylene or polypropylene glycol di-C₁₋₄ alkyl ethers, in particular the dimethyl or diethyl ethers of diethylene glycol or dipropylene glycol, and mixtures of two or more thereof. With dimethyl diethylene glycol in particular, an acceptable cure is achieved even under less favorable application conditions (low atmospheric moisture, low temperature). For further details of plasticizers, reference is made to the relevant technical chemistry literature. Plasticizers can be incorporated into the preparations in amounts of between 0 and 40, preferably between 0 and 20 wt. % (relative to the overall composition).

“Stabilizers” within the meaning of this invention are understood to be antioxidants, UV stabilizers or hydrolysis stabilizers. Examples thereof are the commercial sterically hindered phenols and/or thio ethers and/or substituted benzotriazoles, such as for example Tinuvin 327 (Ciba Specialty Chemicals), and/or HALS-type amines (Hindered Amine Light Stabilizers), such as for example Tinuvin 770 (Ciba Specialty Chemicals). Within the context of the present invention it is preferable for a UV stabilizer to be used which bears a silyl group and which is incorporated into the end product on crosslinking or curing. The products Lowilite 75, Lowilite 77 (Great Lakes, USA) are particularly suitable for this purpose. Benzotriazoles, benzophenones, benzoates, cyanoacrylates, acrylates, sterically hindered phenols, phosphorus and/or sulfur can furthermore also be added. The preparation according to the invention can contain up to around 2 wt. %, preferably around 1 wt. %, of stabilizers. The preparation according to the invention can furthermore contain up to around 7 wt. %, in particular up to around 5 wt. %, of antioxidants.

All known compounds which can catalyze the hydrolytic cleavage of the hydrolyzable groups of the silane groupings and the subsequent fusing of the Si—OH group to siloxane groupings (crosslinking reaction or adhesion-promoting function) can be used as catalysts. Examples of these are titanates such as tetrabutyl titanate and tetrapropyl titanate, tin carboxylates such as dibutyl tin dilaurate (DBTL), dibutyl tin diacetate, dibutyl tin diethyl hexanoate, dibutyl tin dioctoate, dibutyl tin dimethyl maleate, dibutyl tin diethyl maleate, dibutyl tin dibutyl maleate, dibutyl tin diiosooctyl maleate, dibutyl tin ditridecyl maleate, dibutyl tin dibenzyl maleate, dibutyl tin maleate, dibutyl tin diacetate, tin octaoate, dioctyl tin disteareate, dioctyl tin dilaurate, dioctyl tin diethyl maleate, dioctyl tin diisooctyl maleate, dioctyl tin diacetate, and tin naphthenoate; tin alkoxides such as dibutyl tin dimethoxide, dibutyl tin diphenoxide, and dibutyl tin diisopropoxide; tin oxides such as dibutyl tin oxide, and dioctyl tin oxide; reaction products between dibutyl tin oxides and phthalic acid esters, dibutyl tin bisacetyl acetonate; organoaluminum compounds such as aluminum trisacetyl acetonate, aluminum trisethyl acetoacetate, and diisopropoxyaluminum ethyl acetoacetate; chelate compounds such as zirconium tetraacetyl acetonate, and titanium tetraacetyl acetonate; lead octanoate; amine compounds or salts thereof with carboxylic acids, such as butylamine, octylamine, laurylamine, dibutylamines, monoethanolamines, diethanolamines, triethanolamine, diethylene triamine, triethylene tetramine, oleylamines, cyclohexylamine, benzylamine, diethyl aminopropylamine, xylylene diamine, triethylene diamine, guanidine, diphenyl guanidine, 2,4,6-tris(dimethylaminomethyl)phenol, morpholine, N-methylmorpholine, 2-ethyl-4-methylimidazole, and 1,8-diazabicyclo-(5.4.0)-undecene-7 (DBU), a low-molecular-weight polyamide resin obtained from an excess of a polyamine and a polybasic acid, adducts of a polyamine in excess with an epoxide, silane adhesion promoters with amino groups, such as 3-aminopropyl trimethoxysilane, and N-(β-aminoethyl)aminopropylmethyl dimethoxysilane. The catalyst, preferably mixtures of several catalysts, is used in an amount of 0.01 to around 5 wt. %, relative to the total weight of the preparation.

A preparation according to the invention can additionally contain fillers. Chalk, lime dust, precipitated and/or pyrogenic silica, zeolites, bentonites, magnesium carbonate, kieselguhr, alumina, clay, talc, titanium oxide, iron oxide, zinc oxide, sand, quartz, cristobalite, flint, mica, glass powder and other ground mineral substances, for example, are suitable here. Organic fillers can also be used, in particular carbon black, graphite, wood fibers, wood flour, sawdust, cellulose, cotton, pulp, cotton, wood chips, chopped straw, chaff, ground walnut shells and other chopped fibers. Short fibers such as glass fibers, glass filament, polyacrylonitrile, carbon fibers, Kevlar fibers or polyethylene fibers can also be added. Aluminum powder is also suitable as a filler.

The pyrogenic and/or precipitated silicas advantageously have a BET surface area of 10 to 90 m²/g. Their use brings about no additional rise in the viscosity of the preparation according to the invention but contributes to a reinforcement of the cured preparation.

It is also possible to use pyrogenic and/or precipitated silicas having a larger BET surface area, advantageously of 100 to 250 m²/g, in particular 110 to 170 m²/g, as a filler. By virtue of the larger BET surface area it is possible to achieve the same effect, for example reinforcement of the cured preparation, with a smaller percentage by weight of silica. In this way further substances can be used to improve the preparation according to the invention with regard to other requirements.

Hollow beads having a mineral shell or a plastic shell are also suitable as fillers. These can be hollow glass beads, for example, which are available commercially under the trade name Glass Bubbles®. Plastic-based hollow beads are available for example under the trade name Expancel® or Dualite®. These are composed of inorganic or organic substances, each having a diameter of 1 mm or less, preferably 500 μm or less.

Fillers which impart thixotropic properties to the preparations are preferred for some applications. Such fillers are also described as rheological auxiliary agents, for example hydrogenated castor oil, fatty acid amides or swellable plastics such as PVC. To enable them to be easily squeezed out of a dispensing device (e.g. tube), such preparations have a viscosity of 30,000 to 150,000, preferably 40,000 to 80,000 mPas, or also 50,000 to 60,000 mPas.

The fillers are preferably used in an amount of 1 to 80 wt. %, preferably 5 to 60 wt. %, relative to the total weight of the preparation.

Examples of suitable pigments are titanium dioxide, iron oxides or carbon black.

It often makes sense to further stabilize the preparations according to the invention against moisture penetration using desiccants, to further increase the shelf life. There is occasionally also a need to lower the viscosity of the adhesive or sealant according to the invention for certain applications through the use of a reactive thinner. All compounds which can be mixed with the adhesive or sealant to lower its viscosity and which have at least one binder-reactive group can be used as reactive thinners.

The following substances, for example, can be used as reactive thinners: polyalkylene glycols reacted with isocyanatosilanes (e.g. Synalox 100-50B, DOW), carbamatopropyl trimethoxysilane, alkyl trimethoxysilane, alkyl triethoxysilane, methyl trimethoxysilane, methyl triethoxysilane and vinyl trimethoxysilane (Dynasylan VTMO, Evonik or Geniosil XL 10, Wacker), vinyl triethoxysilane, phenyl trimethoxysilane, phenyl triethoxysilane, octyl trimethoxysilane, tetraethoxysilane, vinyl dimethoxymethylsilane (XL12, Wacker), vinyl triethoxysilane (GF56, Wacker), vinyl triacetoxysilane (GF62, Wacker), isooctyl trimethoxysilane (10 Trimethoxy), isooctyl triethoxysilane (10 Triethoxy, Wacker), N-trimethoxysilylmethyl-O-methyl carbamate (XL63, Wacker), N-dimethoxy(methyl)silylmethyl-O-methyl carbamate (XL65, Wacker), hexadecyl trimethoxysilane, 3-octanoyl thio-1-propyl triethoxysilane, aminosilanes, such as e.g. 3-aminopropyl trimethoxysilane (Dynasylan AMMO, Evonik or Geniosil GF96, Wacker), and partial hydrolyzates of the aforementioned compounds.

The following polymers from Kaneka Corp can furthermore likewise be used as reactive thinners: MS S203H, MS S303H, MS SAT 010, and MS SAX 350.

Silane-modified polyethers which derive for example from the reaction of isocyanatosilane with Synalox grades can likewise be used.

Many of the aforementioned silane-functional reactive thinners simultaneously have a drying and/or adhesion-promoting action in the preparation. These reactive thinners are used in amounts of between 0.1 and 15 wt. %, preferably between 1 and 5 wt. %, relative to the total weight of the preparation.

Also suitable as adhesion promoters, however, are tackifiers such as hydrocarbon resins, phenolic resins, terpene-phenolic resins, resorcinol resins or derivatives thereof, modified or unmodified rosin acids or esters (abietic acid derivatives), polyamines, polyaminoamides, anhydrides and anhydride-containing copolymers. The addition of polyepoxide resins in small amounts can also improve adhesion on some substrates. To this end the solid epoxide resins having a molecular weight of over 700 are then preferably used in finely ground form. If tackifiers are used as adhesion promoters, the nature and amount thereof depends on the adhesive/sealant composition and on the substrate to which this is applied. Typical tackifying resins (tackifiers) such as for example terpene-phenolic resins or rosin acid derivatives are used in concentrations of between 5 and 20 wt. %, typical adhesion promoters such as polyamines, polyaminoamides or phenolic resins or resorcinol derivatives are used in the range between 0.1 and 10 wt. %, relative to the overall composition of the preparation.

The preparation according to the invention is prepared according to known methods by intimate mixing of the constituents in suitable dispersing units, for example high-speed mixers, compounders, planetary mixers, planetary agitators, internal mixers, Banbury mixers, twin-screw extruders and similar mixing units known to the person skilled in the art.

A preferred embodiment of the preparation according to the invention can contain:
5 to 50 wt %, preferably 10 to 40 wt. %, of one or more of the silylated polyurethanes according to the invention,
0 to 30 wt. %, less than 20 wt. %, particularly preferably less than 10 wt. %, of plasticizers,
0 to 80 wt. %, preferably 20 to 60 wt. %, particularly preferably 30 to 55 wt. %, of fillers.
   The embodiment can also contain further auxiliary substances.

The entirety of all constituents adds to 100 wt. %, wherein the sum of the aforementioned main constituents alone does not have to add to 100 wt. %.

The silylated polyurethane prepolymers according to the invention cure with ambient atmospheric moisture to form low-modulus polymers, such that low-modulus, moisture-curing adhesive and sealant preparations can be prepared from these prepolymers with the aforementioned auxiliary substances and additives. Adhesives, sealants and coating compounds based on a method according to the invention and/or on a polyether according to the invention correspondingly have the characteristic feature of outstanding extensibility and elasticity and can moreover be assembled from relatively short-chain, readily available and easily handled constituents.

The embodiment example below is intended to illustrate the invention in more detail, wherein the choice of example is not intended to limit the scope of the subject matter of the invention.

### EXAMPLES

### Example 1

### Polymer Synthesis

The entire reaction took place under nitrogen and with exclusion of moisture. Polypropylene glycol 8000 (PPG) was first dried at 50° C. under vacuum (0.9 mbar) for 7 hours. 3.59 g of potassium tert-butoxide (97% corresponding to 3.48 g of active substance=30.9 mmol) were placed in a column and cooled with ice to 0° C. 128 g of the dried PPG (OH value=14, M=8000 g/mol, corresponding to 15.9 mmol) were added and the mixture was stirred with a KPG stirrer for 1 h at 0° C. and then for 3 h at room temperature. 2.21 g of 1,3-bis(bromomethyl)benzene (95% corresponding to 2.10 g of active substance=8 mmol) were added and the mixture was stirred for a further 24 h at room temperature with a supply of nitrogen.

Then the nitrogen supply was ended and bleaching clay was added (TriSyl 300). The bleaching clay was filtered off and the process optionally repeated (to remove turbidity as completely as possible). A colorless to pale yellow, clear, highly viscous liquid was obtained (OH value 10, corresponding to M=12,000 g/mol).

The sample of polypropylene glycol prepared in this way was reacted with the isocyanatosilane GF 40 (Wacker) in a stoichiometric excess and a film was drawn which was cured under atmospheric moisture.

### Test Conditions for the Cured Polymer Films

The time to form a skin (skin-over time/SOT) and the time to form a tack-free film (tack-free time/TFT) were determined for the mixture.

The aforementioned mixtures were also applied in a film thickness of 2 mm to glass sheets covered with polyether film. After being stored for 7 days (23° C., 50% relative humidity), specimens (S2 specimens) were punched out from these films and the mechanical data (modulus at 50, 100 and 200% elongation and ultimate elongation) were determined by reference to DIN EN 27389 and DIN EN 28339.

| SOT: | 12 | min |
|---|---|---|
| TFT: | 24 | h |
| Breaking stress: | 0.56 | N/mm² |
| Elongation: | 90% | |
| E-50: | 0.44 | N/mm² |
| E-100: | 0.66 | N/mm² |

### Preparation of Curable Preparations:

25 parts by weight of the polymer mixture prepared in Example 1 were then intimately mixed in a stirred-tank reactor with 20 parts by weight of diisoundecyl phthalate (DIUP) for 30 s using a SpeedMixer. This was followed by the addition of fillers and further additives as described in the instructions below for comparative example 2 (for quantities see Example 3 in the table below, all quantities are parts by weight). For the purposes of comparison a curable preparation was prepared from a polymer according to the teaching of WO2005/042610 (Example 2 in the table) in the same way.

### Example 2

### Comparative Example, According to WO2005/042610

282 g (15 mmol) of polypropylene glycol 18000 (hydroxyl value=6.0) were dried in a 500 ml three-necked flask at 100° C. under vacuum. 0.06 g (0.02%) of dibutyl tin dilaurate were added under a nitrogen atmosphere at 80° C. and then 7.2 g (32 mmol) of isocyanatopropyl trimethoxysilane (% NCO=18.4) were added. After stirring for one hour at 80° C. the polymer formed was cooled and mixed with 6 g of vinyl trimethoxysilane. The clear, colorless product had an isocyanate content of 0.01% (theoretically: % NCO=0.03). The product was stored in a moisture-proof glass vessel under a nitrogen atmosphere.

The time to form a skin (skin-over time/SOT) and the time to form a tack-free film (tack-free time/TFT) were determined for these preparations.

The preparations were also applied in a film thickness of 2 mm to glass sheets covered with polyether film. After being stored for 7 days (23° C., 50% relative humidity), specimens (S2 specimens) were punched out from these films and the mechanical data (modulus, elongation, resilience) were determined by reference to DIN EN 27389 and DIN EN 28339.

As the test results in the table below show, the preparation according to the invention (Example 3) exhibits very similar skin-over times, setting times, ultimate elongation and resilience to the preparation of the comparative example (Example 2). However, the markedly lower breaking stress and the lower E-moduli are advantageous, as the load on the edges of the joint in sealant applications is accordingly lower than is the case with preparations having a higher E-modulus.

| | Example | |
|---|---|---|
| | | 3 |
| | 2 | (according to |
| | (comparison) | the invention) |
| Polymer (comparison) | 25.00 | — |
| Polymer according to Example 1 | — | 25.00 |
| Plasticizer (DIUP) | 20.00 | 20.00 |
| Calcium carbonate | 45.05 | 45.05 |
| Kronos 2056 | 3.35 | 3.35 |
| Tinuvin 327 | 0.30 | 0.30 |
| Tinuvin 770 DF | 0.30 | 0.30 |
| Geniosil XL10 | 1.50 | 1.50 |
| Geniosil GF96 | 0.95 | 0.95 |
| DBTL | 0.05 | 0.05 |
| Results after curing for 7 days at | | |
| 23° C./50% relative humidity | | |
| SOT in min | 25 | 30 |
| TFT in h | 7.00 | 24.00 |
| Breaking stress in N/mm² | 1.03 | 0.78 |
| Elongation in % | 188% | 163% |
| E-50 N/mm² | 0.50 | 0.36 |
| E-100 N/mm² | 0.68 | 0.53 |
| E-200 N/mm² | 1.11 | 0.90 |
| Set in mm/24 hours at 23° C./50% | 1.95 | 1.70 |
| relative humidity | | |
| Resilience in % (after 100% | 90% | 90% |
| elongation for 24 h) | | |
| Residual tackiness | none | none |

1. A method for preparing a silylated polyurethane, comprising:
(A) reacting
(i) at least one polyol compound A having a molecular weight of 500 to 20,000 daltons and an unsaturation of less than 0.02 meq/g
(ii) with a dihalide to form a polyol compound B having an average molecular weight of 4000 to 40,000 daltons and subsequently
(B) reacting this polyol B with one or more isocyanatosilanes of the formula (I):
OCN—R—Si—(R¹)ₘ(—OR²)₃₋ₘ (I)
in which m is 0, 1 or 2, each R² is an alkyl residue having 1 to 4 carbon atoms, each R¹ is an alkyl residue having 1 to 4 carbon atoms and R is a difunctional organic group.

2. A method for preparing a silylated polyurethane, comprising:
(A) reacting
(i) at least one polyol compound A having a molecular weight of 500 to 20,000 daltons, and a terminal unsaturation of less than 0.02 meq/g
(ii) with a dihalide to form a polyol compound B having a molecular weight of 4000 to 40,000 daltons and subsequently
(B) reacting this polyol B with a diisocyanate in stoichiometric excess of the polyol to form a polyurethane prepolymer C and subsequently
(C) reacting this prepolymer C with one or more isocyanatosilanes of the formula (I):
OCN—R—Si—(R¹)ₘ(—OR²)₃₋ₘ (I)
in which m is 0, 1 or 2, each R² is an alkyl residue having 1 to 4 carbon atoms, each R¹ is an alkyl residue having 1 to 4 carbon atoms and R is a difunctional organic group.

3. The method according to claim 2, wherein at least one compound which is monofunctional with regard to isocyanates, selected from monoalcohols, monomercaptans, monoamines or mixtures thereof, is additionally used in the reaction (B), and the proportion of monofunctional compound in the mixture of polyol and the monofunctional compound is 1 to 40 mol %.

4. The method according to claims 1, wherein 1,3-bis(bromomethyl)benzene is used as the dihalide.

5. The method according to claim 1, wherein R is a difunctional straight-chain or branched alkylene group having 2 to 6 carbon atoms.

6. The method according to claim 1, m being zero or one.

7. The method according to claim 1, the isocyanatosilane of formula (I) being 3-isocyanatopropyl trimethoxysilane or 3-isocyanatopropyl triethoxysilane.

8. A silylated polyurethane, prepared by the method of claim 1.

9. A silylated polyurethane, prepared by the method of claim 2.

10. The silylated polyurethane according to claim 9, wherein at least one compound which is monofunctional with regard to isocyanates, selected from monoalcohols, monomercaptans, monoamines or mixtures thereof, is additionally used in the reaction (B), and the proportion of monofunctional compound in the mixture of polyol and the monofunctional compound is 1 to 40 mol %.

11. The silylated polyurethane according to claims 8, wherein 1,3-bis(bromomethyl)benzene is used as the dihalide.

12. The silylated polyurethane according to claims 8, m being zero or one.

13. The silylated polyurethane according to claims 8, the isocyanatosilane of formula (I) being 3-isocyanatopropyl trimethoxysilane or 3-isocyanatopropyl triethoxysilane.

14. The silylated polyurethane according to claims 9, the diisocyanate compound being selected from the group consisting of 2,4-toluene diisocyanate, 2,6-toluene diisocyanate, 4,4′-diphenylmethane diisocyanate, 2,4′-diphenylmethane diisocyanate, 1-isocyanato-3,3,5-trimethyl-5-isocyanatomethyl cyclohexane (isophorone diisocyanate, IPDI), 4,4′-dicyclohexylmethane diisocyanate isomers, tetramethylxylylene diisocyanate (TMXDI), and mixtures thereof.

15. An adhesive, sealant or coating agent containing one or more silylated polyurethanes according to claim 8.

16. An adhesive, sealant or coating agent containing one or more silylated polyurethanes according to claim 9.
